(19) United States
(12) Patent Application Publication
(10) Pub. No.: US 2025/0279472 A1
(43) Pub. Date: Sep. 4, 2025

(54) WIDE OPERATING TEMPERATURE RANGE SECONDARY LITHIUM-ION BATTERIES

(71) Applicant: Nano and Advanced Materials Institute Limited, Hong Kong (HK)

(72) Inventors: Shengbo LU, Hong Kong (HK); Lang WANG, Hong Kong (HK); Kin Chung HUI, Hong Kong (HK); Qiuhong WANG, Hong Kong (HK); Tze Lok Andy CHAN, Hong Kong (HK); Soon Yee LIEW, Hong Kong (HK); Wing Lung HON, Hong Kong (HK); Chenmin LIU, Hong Kong (HK)

(21) Appl. No.: 18/590,980

(22) Filed: Feb. 29, 2024

(51) Int. Cl. H01M 10/0567; H01M 10/0525; H01M 10/0568; H01M 10/0569; H01M 50/491

(52) U.S. Cl. CPC H01M 10/0567; H01M 10/0525; H01M 10/0568; H01M 10/0569; H01M 50/491; H01M 2300/0034; H01M 2300/0042

(57) ABSTRACT

A wide operating temperature range secondary lithium-ion battery designed is provided. The battery incorporates a cathode with lithium-based materials, including lithium manganese oxide, lithium cobalt oxide, lithium nickel manganese cobalt oxide, or lithium iron phosphate, and an anode with materials such as silicon, silicon oxide, carbon nanotubes, lithium metal, graphene, or graphite. A porous polymer separator, with porosity ranging from approximately 30% to 90%, ensures efficient ion transport. The non-aqueous electrolyte is composed of two or more lithium salts, including LiPF₆, and a solvent mixture of carbonates and carboxylate esters with an asymmetric molecule structure. An electrolyte additive is introduced to synergistically react with the electrolyte solvents, forming a stable solid electrolyte interphase enriched with inorganic lithium components, surpassing organic lithium components. This battery configuration results in a lithium-ion battery with an extended operating temperature range from −35° C. to 85° C. for reliable energy storage under varying environmental conditions.

### FIELD OF THE INVENTION

The present invention generally relates to lithium-based batteries. More specifically the present invention relates to wide operating temperature range secondary lithium-ion batteries.

### BACKGROUND OF THE INVENTION

Built upon the fundamental “rocking-chair concept,” lithium-ion batteries (LIBs) have become indispensable in the realm of electrochemical energy storage, exerting a profound influence on our daily lives. The increasing demand for electronic devices that can operate across a wide temperature range (−35° C. to 80° C.) has spurred the necessity for lithium-ion batteries capable of such performance. These batteries serve diverse applications, from emergency call batteries in vehicles to energy storage systems, communication base stations, and drones functioning in environments with significant temperature variations.

An illustrative application of this technology is in the domain of emergency call batteries tailored for the next-generation automobile emergency call (eCall) system leveraging 5G technology. In critical situations, this specialized battery ensures the swift activation of emergency services, potentially saving lives in the aftermath of accidents.

These traditional batteries experience a significant surge in internal resistance at low temperatures due to the low ionic conductivity of the electrolyte. Simultaneously, they encounter severe side reactions, such as the decomposition of lithium salts, at high temperatures, resulting in diminished output voltage and current.

Understanding that the low-temperature discharge capability and high-temperature stability of LIBs hinge heavily on electrolyte performance, optimizing Li-ion conductivity at low temperatures and ensuring electrolyte stability at high temperatures becomes paramount for enhancing battery wide-temperature performance. In response to this need, the field is actively seeking a wide operating temperature range secondary lithium-ion battery with improved electrolyte stability at high temperatures; therefore, the present invention addresses this need.

### SUMMARY OF THE INVENTION

It is an objective of the present invention to provide a wide operating temperature range secondary lithium-ion battery to solve the aforementioned technical problems.

In accordance with a first aspect of the present invention, a wide operating temperature range secondary lithium-ion battery is provided. Particularly, the wide operating temperature range secondary lithium-ion battery includes:
a cathode including one or more lithium-based materials selected from the group consisting of lithium manganese oxide, lithium cobalt oxide, lithium nickel manganese cobalt oxide, and lithium iron phosphate;
an anode including one or more materials selected from the group consisting of silicon, silicon oxide, carbon nanotubes, lithium metal, graphene, and graphite;
at least one porous polymer separator having a porosity from approximately 30% to 90%; and
a non-aqueous electrolyte, including:
   two or more lithium salts, wherein at least one of the two or more lithium salts includes LiPF₆;
   an electrolyte including one or more solvents including carbonates, carboxylate esters with an asymmetric molecule structure; and
   an electrolyte additive.

In accordance with one embodiment of the present invention, the electrolyte solvent and the electrolyte additive are selected such that they synergistically react together to form a stable solid electrolyte interphase having a quantity of inorganic lithium components higher than a quantity of organic lithium components, such that the lithium-ion battery has an operating temperature range of −35° C. to 80° C.

In accordance with another embodiment of the present invention, the carboxylate esters with an asymmetric molecule structure are carboxylate esters having 20-80% volume percentage concentration of asymmetric molecule structure.

In accordance with one embodiment of the present invention, the carboxylate esters are selected from ethyl acetate (EA), methyl propionate (MP), methyl butyrate (MB), ethyl butyrate (EB), propyl butyrate (PB), ethyl propionate (EP), propyl propionate (PP), or any combinations thereof.

In accordance with one embodiment of the present invention, the concentration of LiPF₆ ranges from 0.5 to 1.5 M.

In accordance with one embodiment of the present invention, the electrolyte solvent is a combination of materials selected from ethylene carbonate (EC), diethyl carbonate (DEC), ethyl methyl carbonate (EMC), or propylene carbonate (PC).

In accordance with one embodiment of the present invention, the electrolyte solvent has a volume percentage concentration of 5-50%.

In accordance with one embodiment of the present invention, the electrolyte additive is selected from one or more lithium difluoro (oxalato) borate (LiDFOB), lithium difuorophosphate (LiPO₂F₂), fluoroethylene carbonate (FEC), vinylene carbonate (VC), and tris(trimethylsilyl) phosphate (TMSP).

In accordance with one embodiment of the present invention, the electrolyte additive has a volume percentage concentration of 0-5%.

In accordance with one embodiment of the present invention, the two or more lithium salts further includes one or more 0.1-1M of LiTFSI, 0.1-1M of LiFSI, and 0.1-1M of LiBF₄.

In accordance with one embodiment of the present invention, the inorganic lithium components comprise lithium fluoride, lithium oxide, lithium superoxide and lithium carbonates, and the organic lithium components comprise polycarbonates and lithium alkyl carbonates with C—O or C═O bond.

In accordance with one embodiment of the present invention, the inorganic lithium components have a profile of the intensity of lithium fluoride is higher than the intensity of lithium carbonate under X-ray photoelectron spectroscopy.

In accordance with another embodiment of the present invention, the inorganic lithium components have a profile of the intensity of lithium fluoride is higher than 16 over the intensity of lithium carbonate under X-ray photoelectron spectroscopy.

In accordance with one embodiment of the present invention, the intensity of lithium fluoride is higher the intensity of organic lithium components under X-ray photoelectron spectroscopy.

In accordance with another embodiment of the present invention, the intensity of lithium fluoride is higher than 36 over the intensity of organic lithium components under X-ray photoelectron spectroscopy.

In accordance with one embodiment of the present invention, the battery is able to discharge at 1-3 C under −35° C. with a voltage higher than or equal to 2V for a battery with lithium iron phosphate cathode materials.

In accordance with one embodiment of the present invention, the battery is able to discharge at 1-3 C in a constant power mode under −35° C. with a voltage higher than or equal to 2V for a battery with lithium iron phosphate cathode materials.

In accordance with one embodiment of the present invention, the battery is able to discharge at 1-3 C in a constant power mode under −35° C. with a voltage higher than or equal to 3V for a battery with lithium nickel manganese cobalt oxide cathode materials.

In accordance with one embodiment of the present invention, the battery is able to discharge at 1-3 C under −20° C. with a voltage higher than or equal to 2V for a battery with lithium iron phosphate cathode materials after 5.5 years storage with temperature exceeding 40° C.

In accordance with one embodiment of the present invention, the battery is able to discharge at 1-3 C under −20° C. with a voltage higher than or equal to 3V for a battery with lithium nickel manganese cobalt oxide cathode materials after 5.5 years storage with temperature exceeding 40° C.

In accordance with one embodiment of the present invention, the battery has a storage temperature ranging from −35° C. to 85° C.

### BRIEF DESCRIPTION OF THE DRAWINGS

Embodiments of the invention are described in more details hereinafter with reference to the drawings, in which:

FIGS. 1A-1B depict a comparison between solid electrolyte interphases (SEI), in which FIG. 1A shows a SEI formed in conventional carbonate-based electrolytes, and FIG. 1B displays a stable inorganic-rich SEI formed in the present electrolyte, showing the synergistic effect of electrolyte solvent and additives;

FIG. 2 depicts the constant power discharge curves of batteries utilizing the electrolyte samples WT1, WT2, WT3, WT4, WT5 and WT6 at −35° C.;

FIG. 3 depicts the capacity recovery of LFP/graphite batteries using electrolyte samples WT1, WT2, WT3, WT4, WT5 and WT6 electrolytes after 80° C. aging treatment for 23 days compared to fresh cells;

FIGS. 4A-4H depict the C1s XPS spectra analysis of surface and depth profiles (after 75 s Ar etching) of graphite anode using electrolyte samples WT1, WT2, WT3 and WT5 after 80° C. aging treatment for 23 days, in which FIGS. 4A and 4B respectively show the spectra of surface and depth profiles of graphite anode with electrolyte WT1, FIGS. 4C and 4D respectively show the spectra of surface and depth profiles of graphite anode with electrolyte sample WT2, FIGS. 4E and 4F respectively show the spectra of surface and depth profiles of graphite anode with electrolyte sample WT3, and FIGS. 4G and 4H respectively show the spectra of surface and depth profiles of graphite anode with electrolyte sample WT5; and

FIGS. 5A-5D respectively depict the F1s XPS spectra analysis of etched graphite anode using electrolyte samples WT1 (FIG. 5A), WT2 (FIG. 5B), WT3 (FIG. 5C) and WT5 (FIG. 5D) after 80° C. aging treatment for 23 days.

### DETAILED DESCRIPTION

In the following description, wide operating temperature range secondary lithium-ion batteries and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The solid electrolyte interphase (SEI) is a critical component in lithium-ion batteries, forming on the surface of the electrodes as a result of repeated charging and discharging cycles. It acts as a protective layer, preventing further reactions between the electrode materials and the electrolyte, which is essential for the long-term stability and performance of the battery. Therefore, the SEI must be stable over numerous charge and discharge cycles to maintain the long-term efficiency of the battery. Understanding the composition and properties of the organic and inorganic layers in the SEI is crucial for designing battery materials and electrolytes that promote the formation of a stable and efficient SEI, ultimately enhancing the performance, safety, and lifespan of lithium-ion batteries.

The SEI is typically composed of both organic and inorganic components, and it plays a crucial role in the overall function of the battery. The organic layer of the SEI is primarily formed through the reduction of electrolyte components at the electrode surface during the initial charging cycles. The organic layer provides a passivation barrier that prevents further electrolyte reduction at the electrode surface. It also acts as a semi-permeable membrane, allowing the passage of lithium ions while inhibiting the passage of larger molecules.

On the other hand, the inorganic layer of the SEI is formed by the continuous decomposition and reformation of lithium salts and additives from the electrolyte during cycling. This layer is rich in lithium salts and contributes to the overall stability of the SEI. It is less permeable to electrolyte solvents, enhancing the resistance of the SEI against further electrolyte decomposition. The inorganic layer also aids in providing mechanical strength to the SEI.

However, a thicker organic layer can impede the easy transport of lithium ions between the electrolyte and the electrode. This can result in increased internal resistance within the battery, leading to lower ionic conductivity and reduced charge/discharge efficiency. Additionally, a thicker organic layer may increase the voltage required for the formation of the SEI during the initial cycles, leading to increased energy consumption and may contribute to issues like electrolyte decomposition or side reactions. Furthermore, excessive thickness of the organic layer can contribute to capacity loss and reduced cycling stability over the battery's lifetime. Continuous growth of the SEI, especially if dominated by a thick organic layer, may result in increased impedance, deteriorating the battery's performance with each cycle. Moreover, a thick organic layer may contribute to higher internal resistance and elevated temperatures during operation. Elevated temperatures can increase the risk of thermal runaway, which is a safety concern in lithium-ion batteries.

Therefore, the aforementioned shortcomings regarding a thicker organic layer in SEI emphasize that optimizing the thickness and composition of the SEI, balancing between organic and inorganic components, is a critical aspect of battery design to achieve a stable, high-performance, and safe lithium-ion battery.

In order to overcome this, the present invention introduces a wide operating temperature range secondary lithium-ion battery with a particular non-aqueous electrolyte formula to optimize the thickness and composition of the SEI, resulting in the ability of the battery to function over a wide temperature range.

The battery incorporates a cathode comprising lithium-based materials such as lithium manganese oxide, lithium cobalt oxide, lithium nickel manganese cobalt oxide, or lithium iron phosphate and their combinations. The anode consists of materials such as silicon, silicon oxide, carbon nanotubes, lithium metal, graphene, or graphite. Additionally, a porous polymer separator with a porosity ranging from approximately 30% to 90% is integrated into the battery structure, enhancing its efficiency.

A distinctive element of this battery is its non-aqueous electrolyte, which includes two or more lithium salts, with at least one salt containing LiPF₆. The electrolyte includes selected solvents, encompassing carbonates, and carboxylate esters with an asymmetric molecule structure. Additionally, an electrolyte additive is introduced, strategically chosen for its synergy with the electrolyte solvents. This unique combination of electrolyte solvents and additives facilitates the formation of a stable solid electrolyte interphase (SEI), with a higher quantity of inorganic lithium components than organic ones. This structural feature enables the lithium-ion battery to operate efficiently within an extended temperature range of −35° C. to 80° C.

In one embodiment, the carboxylate esters with an asymmetric molecule structure are carboxylate esters having 20-80% volume percentage concentration of asymmetric molecule structure. In another embodiment, the carboxylate esters are selected from ethyl acetate (EA), methyl propionate (MP), methyl butyrate (MB), ethyl butyrate (EB), propyl butyrate (PB), ethyl propionate (EP), propyl propionate (PP), or any combinations thereof.

Key details include the use of carboxylate esters with an asymmetric molecule structure, with an optimal concentration of 20-80% volume percentage. The concentration of LiPF₆ is carefully controlled within the range of 0.5 to 1.5 M for optimal battery performance. The electrolyte solvent is a combination of materials like ethylene carbonate (EC), diethyl carbonate (DEC), ethyl methyl carbonate (EMC), or propylene carbonate (PC), with a volume percentage concentration ranging from 5% to 50%. The electrolyte additive, selected from lithium difluoro (oxalato) borate (LiDFOB), lithium difluorophosphate (LiPO₂F₂), fluoroethylene carbonate (FEC), vinylene carbonate (VC), and tris(trimethylsilyl) phosphate (TMSP), is incorporated with a volume percentage concentration of 0-5%. In addition to lithium salts, further fine-tuning is achieved by including one or more LiTFSI, LiFSI, and LiBF₄ with concentrations ranging from 0.1 to 1M.

For SEI, the inorganic lithium components include lithium fluoride, lithium oxide, lithium superoxide, and lithium carbonates, while the organic lithium components encompass polycarbonates and lithium alkyl carbonates with C—O or C═O bond. Unique to this design is the profile of inorganic lithium components, where the intensity of lithium fluoride is significantly higher than that of lithium carbonate or organic lithium components, as demonstrated by X-ray photoelectron spectroscopy. This balance or proportion between organic and inorganic lithium components is crucial for the battery's overall stability and efficiency. For instance, X-ray photoelectron spectroscopy is employed to validate the inorganic lithium components' profile, ensuring that the intensity of lithium fluoride is higher than 16 over the intensity of lithium carbonate. This validation extends to an intensity higher than 36 over the intensity of organic lithium components. These analytical techniques guarantee the battery's adherence to the present battery.

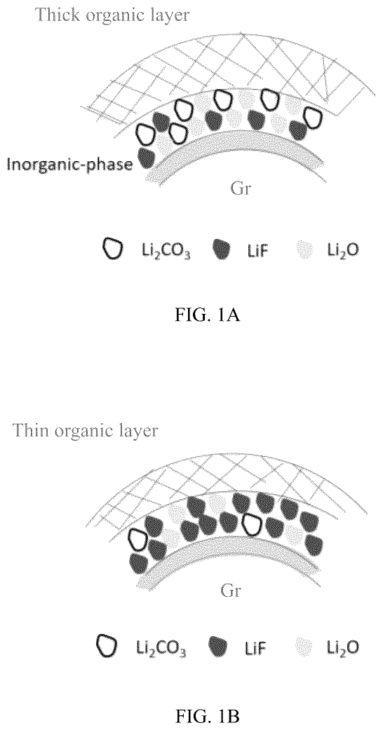

As shown in FIG. 1A, the conventional SEI formed in carbonates-based electrolyte contains a thicker organic-layer, compared with the SEI formed by the non-aqueous electrolyte of the present invention as depicted in FIG. 1B. Notably, the SEI formed in conventional batteries has a higher concentration of Li₂CO₃ in inorganic layer comparing to the SEI formed in the present batteries. Consequently, the SEI formed in the present batteries delivers a faster lithium-ion transport and reduces the content of unstable Li₂CO₃, allowing the stable and mechanically robust LiF become more dominant in the inorganic layer.

Furthermore, the battery demonstrates exceptional discharge capabilities under challenging conditions. Specifically, it can discharge at 1-3 C under −35° C. with a voltage higher than or equal to 2V for a battery with lithium iron phosphate cathode materials. This discharge capability extends to constant power modes, with the ability to discharge at 1-3 C under −35° C. with a voltage higher than or equal to 2V for lithium iron phosphate cathode materials, and at 1-3 C in a constant power mode under −35° C. with a voltage higher than or equal to 3V for lithium nickel manganese cobalt oxide cathode materials. The resilience of the battery is further demonstrated by its ability to discharge at 1-3 C under −20° C. with voltages higher than or equal to 2V for lithium iron phosphate cathode materials and 3V for lithium nickel manganese cobalt oxide cathode materials. Even after 5.5 years of storage with temperatures exceeding 40° C., the battery exhibits consistent discharge capabilities.

It is worth noting that the present invention introduces a specific electrolyte system having specific electrolyte solvents and additives and provides an economical and efficient approach to regulate electrolyte and electrode-electrolyte interphases' properties, ultimately enhancing the wide-temperature capabilities of LIBs. Consequently, this wide operating temperature range secondary lithium-ion battery, with a storage temperature range of −35° C. to 85° C., represents a significant advancement in the field of energy storage, providing a reliable and adaptable solution for various applications and environmental conditions.

### EXAMPLES

### Example 1. Formulations of the Non-Aqueous Electrolyte

The electrolyte formulations for six different samples are detailed in Table 1. WT1, WT2, and WT3 share the same composition of base solvent, and film-forming additives FEC and VC are included. Different formulations include varied amounts of functional additives such as LiDFOB, LiPO₂F₂ and TMSP. In WT4, WT5, and WT6, methyl butyrate (MB) is replaced with ethyl butyrate (EB), and additional functional additives like LiDFOB and LiPO₂F₂ are introduced. Furthermore, in these formulations, a portion of LiPF₆ is replaced with LiFSI.

TABLE 1
Formulations of WT1, WT2, WT3, WT4, WT5 and WT6

| | Component | WT1 | WT2 | WT3 | WT4 | WT5 | WT6 |
|---|---|---|---|---|---|---|---|
| Base solvent | EC | 10% | 10% | 10% | 10% | 10% | 10% |
| (v/v) | PC | 5% | 5% | 5% | 5% | 5% | 5% |
| | EMC | 5% | 5% | 5% | 5% | 5% | 5% |
| | MB | 80% | 80% | 80% | | | |
| | EB | | | | 80% | 80% | 80% |
| Additive (wt.) | VC | 0.5% | 0.5% | 0.5% | 0.5% | 0.5% | 0.5% |
| | FEC | 1.0% | 1.0% | 1.0% | 1.0% | 1.0% | 1.0% |
| | LIDFOB | 1.0% | | | | 1.0% | 1.0% |
| | LiPO₂F₂ | | 1.0% | 1.0% | 1.0% | | |
| | TMSP | | | 1.0% | | | |
| Li Salt | LiPF₆ | 1 M | 1 M | 1 M | 1 M | 1 M | 0.6 M |
| Concentration | LIFSI | | | | | | 0.4 M |

The electrolytes are prepared by simply mixing the solvent, lithium salts and additives. The mixtures are stirred to make sure all components are well dissolved. The solvent MB and EB used in this example are dried by NaH and then purified by distillation.

### Example 2. The Performances of Lithium-Ion Batteries Utilizing these Electrolytes

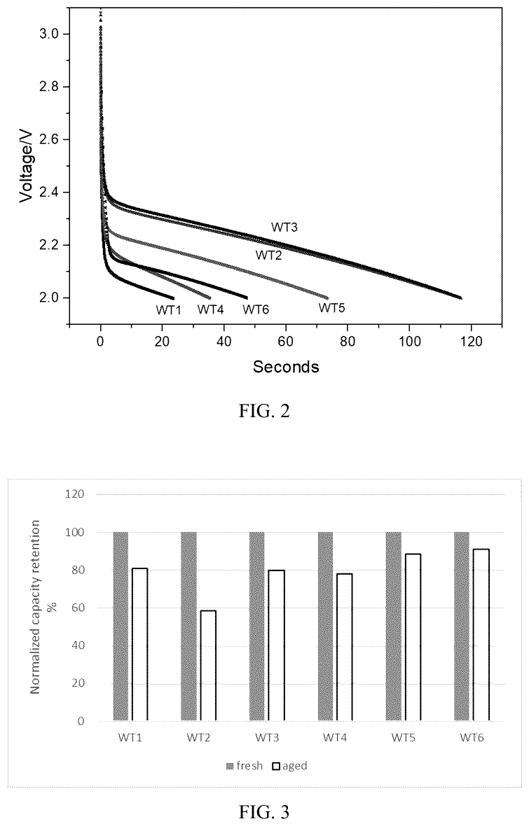

These electrolyte samples are adopted in LFP/graphite batteries for constant power discharge evaluations at −35° C. with a specific area capacity of 2.2 mA/cm² @ 0.1 C. The detected constant power discharge curves are summarized in FIG. 2.

As illustrated in FIG. 2, the constant power discharge mode maintains a discharge rate within the 1-3 C range, leading to a gradual voltage decline. Evaluation of battery formulations involved assessing the discharge time while ensuring voltage remains above 2V for LFP graphite batteries. Prolonged discharge times, especially evident with the wide temperature electrolytes (WT1-6), highlight the critical role of the underlying solvent in achieving optimal low-temperature performance. Among the newly developed electrolytes, WT2 stands out with the longest discharge time at −35° C., credited to the incorporation of the additive LiPO₂F₂.

Furthermore, an assessment of the high-temperature aging characteristics of the wide-temperature electrolytes is conducted under storage conditions of 80° C. FIG. 3 illustrates the capacity retention of batteries employing wide-temperature electrolytes following the aging process. Notably, electrolyte WT2, containing additive LiPO₂F₂ in MB base solvent, exhibits the least capacity retention, in contrast to WT1, which utilizes additive LiDFOB in MB and shows better capacity retention. The inclusion of TMSP in WT3 leads to an enhancement in the capacity retention of WT2. Transitioning from MB to EB base solvent yields improved capacity retention in WT4 and WT5 during high-temperature aging treatment, with WT5, supplemented by LiDFOB, exhibiting higher capacity retention and notable high-temperature performance. Moreover, the incorporation of LiFSI partially replacing LiPF₆ in WT6 results in the most favorable capacity retention. Considering performance trade-offs, the combination of LiPO₂F₂ and MB yields superior low-temperature discharge performance, albeit with compromised high-temperature performance. Conversely, the combination of LiDFOB and MB (WT1) or EB (WT5) showcases good high-temperature stability, with the LiDFOB and EB electrolyte (WT5) also displaying relatively satisfactory low-temperature discharge performance.

Additionally, inductively coupled plasma-optical emission spectroscopy (ICP-OES) is employed for characterizing iron (Fe) dissolution from the LFP cathode subjected to various wide-temperature electrolytes during high-temperature storage. The Fe content in the anode is assessed to measure the extent of Fe dissolution. Following the aging process, graphite anodes are collected and digested into solutions, and the resulting solutions are analyzed using ICP-OES (as detailed in Table 2). Remarkably, the Fe dissolution in batteries utilizing these electrolytes remains relatively moderate. The degree of Fe dissolution shows a strong correlation with the capacity retention of batteries at high temperatures. Batteries exhibiting superior capacity retention demonstrated lower levels of Fe dissolution.

The primary source of Fe dissolution within LFP graphite batteries originates from the corrosion of LFP by hydrofluoric acid (HF), a byproduct of lithium salt decomposition, such as LiPF₆. Under elevated temperatures, the side reactions of LiPF₆ become more pronounced, intensifying the impact of HF. It is shown that the introduction of a scavenger, TMSP (WT3), effectively captures HF and mitigates its deleterious effects caused by LiPF₆ decomposition under high temperature.

TABLE 2
The content of Fe from graphite anode using electrolytes WT1,
WT2, WT3 and WT5 after 80° C. aging treatment for 23 days.

| Electrolytes | WT1 | WT2 | WT3 | WT5 |
|---|---|---|---|---|
| Fe | 67 ppm | 129 ppm | 94 ppm | 48 ppm |

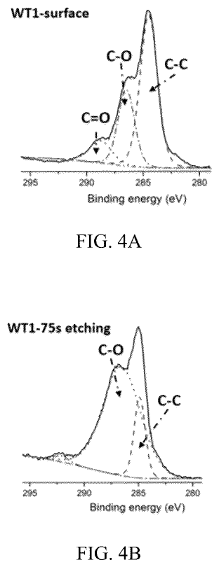

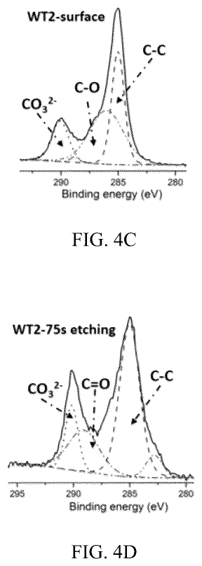

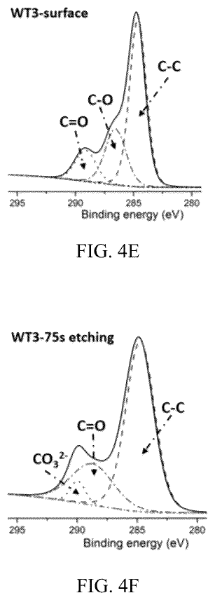

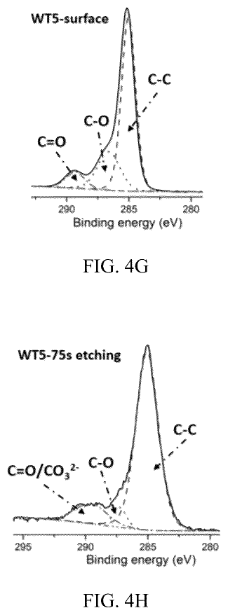

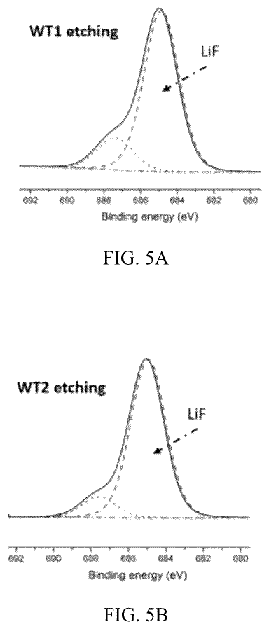

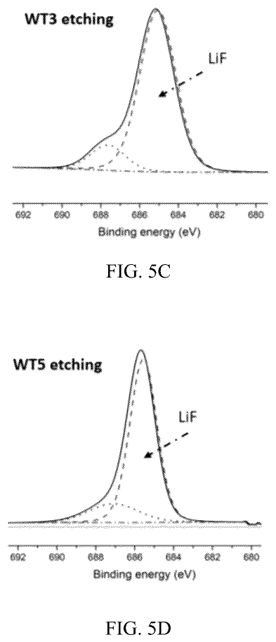

The performance of batteries is significantly influenced by the solid electrolyte interphases (SEI) of the electrodes. After aging at 80° C., the SEI of graphite anodes utilizing wide-temperature electrolytes is investigated using X-ray photoelectron spectroscopy (XPS) in FIGS. 3A-3H and FIGS. 4A-4D, employing argon gas sputtering for surface etching. The C1s spectra of WT1 indicates that MB and LiDFOB contribute to SEI formation with more resistive organic components, resulting in relatively inferior discharge performance at lower temperatures. In contrast, the C1s spectra of WT2 shows that the inclusion of LiPO₂F₂ inhibits the generation of organic components, creating less resistive interphases and subsequently enhancing low-temperature performance. However, WT2's high-temperature stability falls short of that observed in WT1 due to a higher presence of unstable lithium carbonates within WT2.

The introduction of additional scavenger TMSP in WT3 significantly improves high-temperature stability and substantially reduces the formation of lithium carbonates. The organic component, lithium carbonate, is prone to decompose into unstable lithium carbonates in the presence of trace amounts of water. TMSP effectively minimizes the amount of water generated during high-temperature aging, thereby reducing water-induced side reactions. Interestingly, the combination of EB and LiDFOB in WT5 facilitates the formation of a LiF-rich SEI with diminished organic components and unstable lithium carbonates, achieving both low-temperature discharge performance and high-temperature stability through the synergistic effect of solvents and additives.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A wide operating temperature range secondary lithium-ion battery, comprising:
a cathode including one or more lithium-based materials selected from the group consisting of lithium manganese oxide, lithium cobalt oxide, lithium nickel manganese cobalt oxide, and lithium iron phosphate;
an anode including one or more materials selected from the group consisting of silicon, silicon oxide, carbon nanotubes, lithium metal, graphene, and graphite;
at least one porous polymer separator having a porosity from approximately 30% to 90%; and
a non-aqueous electrolyte, comprising:
two or more lithium salts, wherein at least one of the two or more lithium salts includes LiPF₆;
an electrolyte solvent including one or more solvents including carbonates, carboxylate esters with an asymmetric molecule structure; and
an electrolyte additive;
wherein the electrolyte solvent and the electrolyte additive are selected such that they synergistically react together to form a stable solid electrolyte interphase having a quantity of inorganic lithium components higher than a quantity of organic lithium components, such that the lithium-ion battery has an operating temperature range of −35° C. to 80° C.

2. The wide operating temperature range secondary lithium-ion battery of claim 1, wherein the carboxylate esters with an asymmetric molecule structure are carboxylate esters having 20-80% volume percentage concentration of asymmetric molecule structure.

3. The wide operating temperature range secondary lithium-ion battery of claim 2, wherein the carboxylate esters are selected from ethyl acetate (EA), methyl propionate (MP), methyl butyrate (MB), ethyl butyrate (EB), propyl butyrate (PB), ethyl propionate (EP), propyl propionate (PP), or any combinations thereof.

4. The wide operating temperature range secondary lithium-ion battery of claim 1, wherein the concentration of LIPF₆ ranges from 0.5 to 1.5 M.

5. The wide operating temperature range secondary lithium-ion battery of claim 1, wherein the electrolyte solvent is a combination of materials selected from ethylene carbonate (EC), diethyl carbonate (DEC), ethyl methyl carbonate (EMC), or propylene carbonate (PC).

6. The wide operating temperature range secondary lithium-ion battery of claim 5, wherein the electrolyte solvent has a volume percentage concentration of 5-50%.

7. The wide operating temperature range secondary lithium-ion battery of claim 1, wherein the electrolyte additive is selected from one or more lithium difluoro (oxalato) borate (LiDFOB), lithium difuorophosphate (LiPO₂F₂), fluoroethylene carbonate (FEC), vinylene carbonate (VC), and tris(trimethylsilyl) phosphate (TMSP).

8. The wide operating temperature range secondary lithium-ion battery of claim 7, wherein the electrolyte additive has a volume percentage concentration of 0-5%.

9. The wide operating temperature range secondary lithium-ion battery of claim 1, wherein the two or more lithium salts further comprise one or more 0.1-1M of LiTFSI, 0.1-1M of LiFSI, and 0.1-1M of LiBF₄.

10. The wide operating temperature range secondary lithium-ion battery of claim 1, wherein the inorganic lithium components comprise lithium fluoride, lithium oxide, lithium superoxide and lithium carbonates, and the organic lithium components comprise polycarbonates and lithium alkyl carbonates with C—O or C═O bond.

11. The wide operating temperature range secondary lithium-ion battery of claim 10, wherein the inorganic lithium components have a profile of the intensity of lithium fluoride is higher than the intensity of lithium carbonate under X-ray photoelectron spectroscopy.

12. The wide operating temperature range secondary lithium-ion battery of claim 11, wherein the inorganic lithium components have a profile of the intensity of lithium fluoride is at least 16 times higher than the intensity of lithium carbonate under X-ray photoelectron spectroscopy.

13. The wide operating temperature range secondary lithium-ion battery of claim 10, wherein the intensity of lithium fluoride is higher the intensity of organic lithium components under X-ray photoelectron spectroscopy.

14. The wide operating temperature range secondary lithium-ion battery of claim 13, wherein the intensity of lithium fluoride is at least 36 times higher the intensity of organic lithium components under X-ray photoelectron spectroscopy.

15. The wide operating temperature range secondary lithium-ion battery of claim 1, wherein the battery is able to discharge at 1-3 C under −35° C. with a voltage higher than or equal to 2V for a battery with lithium iron phosphate cathode materials.

16. The wide operating temperature range secondary lithium-ion battery of claim 1, wherein the battery is able to discharge at 1-3 C in a constant power mode under −35° C. with a voltage higher than or equal to 2V for a battery with lithium iron phosphate cathode materials.

17. The wide operating temperature range secondary lithium-ion battery of claim 1, wherein the battery is able to discharge at 1-3 C in a constant power mode under −35° C. with a voltage higher than or equal to 3V for a battery with lithium nickel manganese cobalt oxide cathode materials.

18. The wide operating temperature range secondary lithium-ion battery of claim 1, wherein the battery is able to discharge at 1-3 C under −20° C. with a voltage higher than or equal to 2V for a battery with lithium iron phosphate cathode materials after 5.5 years storage with temperature exceeding 40° C.

19. The wide operating temperature range secondary lithium-ion battery of claim 1, wherein the battery is able to discharge at 1-3 C under −20° C. with a voltage higher than or equal to 3V for a battery with lithium nickel manganese cobalt oxide cathode materials after 5.5 years storage with temperature exceeding 40° C.

20. The wide operating temperature range secondary lithium-ion battery of claim 1, wherein the battery has a storage temperature ranging from −35° C. to 85° C.
